(19) United States
(12) Patent Application Publication
(10) Pub. No.: US 2015/0010106 A1
(43) Pub. Date: Jan. 8, 2015

(54) Virtual Antenna Ports for Flexible CSI-RS Resource Definition

(71) Applicant: Nokia Solutions and Networks Oy, Espoo (FI)

(72) Inventors: Peter Skov, Beijing (CN); Chun Ye Wang, Beijing (CN); Lilei Wang, Beijing (CN); Li Zhang, Beijing (CN)

(21) Appl. No.: 14/375,148

(22) PCT Filed: Jan. 29, 2012
(86) PCT No.: PCT/CN2012/070742

§ 371 Date: Jul. 29, 2014

(51) Int. Cl. H04L 27/26

(52) U.S. Cl. CPC H04L 27/2626; H04L 27/2646
USPC 375/295

(57) ABSTRACT

An apparatus and a method are provided, by which at least one virtual antenna port is created which includes a plurality of reference signal ports defined in a physical resource block. Information regarding the at least one virtual antenna port including the definition of the reference signal ports is sent to a user equipment, and reference signals are sent on the plurality of reference signal ports to the user equipment

### FIELD OF THE INVENTION

The present invention relates to apparatuses, methods and a computer program product for providing virtual antenna ports for flexible CSI-RS resource definition.

### RELATED BACKGROUND ART

The following meanings for the abbreviations used in this specification apply:

3GPP 3rd Generation Partnership Project

CDM Code Division Multiplexing

CDM-F Code Division Multiplexing-Frequency domain

CDM-T Code Division Multiplexing-Time domain

COMP Coordinated Multi-Point Transmission

CRS Common Reference Signal

CSI-RS Channel State Information Reference Signal

CP Cyclic Prefix

DL Downlink

eNB enhanced Node-B

LTE Long Term Evolution

MIMO Multiple-Input Multiple-Output

OCC Orthogonal Cover Codes

PRB Physical Resource Block

RE Resource Element

RRC Radio Resource Control

RRM Radio Resource Management

UE User Equipment

WI Work Item

Embodiments of the present invention relate to LTE, and in particular to the physical layer structure and more precisely to DL wireless channel physical resources, channel state information and reference signals. According to LTE, a channel state information reference signal (CSI-RS) already specified in 3GPP Rel. 10 standard is used for downlink channel sounding. This CSI-RS standard could be used for channel measurements and for deriving feedback on channel quality and spatial properties as needed.

Lots of physical technologies such as 8tx codebook based single-user MIMO (Re1.10 feature), coherent joint transmission (which might be an important

COMP candidate in current Re1.11 WI) rely on CSI feedback based on CSI-RS ports. Relative accurate channel estimation based on CSI-RS is critical to system performance.

FIG. 5 illustrates all possible CSI-RS resources in Rel. 10. The left figure shows possible resources for 2 CSI-RS ports, which are indicated by 0 and 1. The middle figure shows possible resources for 4 CSI-RS ports, which are indicated by 0, 1, 2 and 3. The right figure shows possible resources for 8 CSI-RS ports, which are indicated by 0, 1, 2, 3, 4, 5, 6 and 7. It is noted that also other resources are indicated, for understanding the present invention, however, only the locations of the CSI-RS resources are important.

FIG. 6 shows a simplified example for a case of 2 CSI-RS ports, which are selected from the possible resources indicated in the left figure of FIG. 5 to be used as indicated.

Thus, due to the low density, there can be problems with estimating accurately sub-band PMI using current Rel. 10 CSI-RS pattern, because of few REs available for doing this estimation (sub-band size in 10 MHz system is 6 PRB so effectively only 6 RE per antenna).

Also for some time 3GPP have been discussing the possibility of standardizing new carrier types which do not support the transmission of Rel-8 LTE common reference signal. In such carriers all UE measurements would be carried out using CSI-RS and such UEs may even use CSI-RS in legacy carriers to make these measurements. Moreover some of these new CSI-RS measurements may be done for different purposes than the measurements currently done. As an example of such a measurement the UE may measure the strength and/or quality of different geographically separated transmission points operating under the same logical cell. CSI-RS based measurements may replace in the future some or all of the existing RRM measurements or they be simply complementing existing RRM measurements.

Assuming that CSI-RS will be used also for RRM like measurements, further consideration is needed. RRM like measurements could be used for operating the cell (re)selection and handover and it is of utmost importance that such measurements are very robust and reliable.

With current Rel-10 CSI-RS design, the number of REs allocated for such UE measurement is very limited especially for 2tx operation (1 RE per antenna per PRB with minimal period of 5 ms, shown in FIG. 5 or 6) so Rel-10 CSI-RS may not in the current form be suitable for making RRM like measurements.

On way to enhance the channel estimation could be to increase the number of RS symbols or to modify the CDM manner for each pair of REs while maintaining Rel-10 backward compatibility. However, this would lead to a complex signalling arrangement and overhead.

### SUMMARY OF THE INVENTION

Embodiments of the present invention address this situation and aim to enhance channel estimation.

According to a first aspect of embodiments of the present invention, an apparatus is provided which comprises an interface configured to provide connection to at least another apparatus, and a processor. The processor is configured to create a at least one virtual antenna port which comprises a plurality of reference signal ports defined in a physical resource block, send information regarding the at least one virtual antenna port including the definition of the reference signal ports via the interface to a user equipment, and send reference signals on the plurality of reference signal ports to the user equipment.

According to a second aspect of embodiments of the present invention, an apparatus is provided which comprises an interface configured to provide connection to at least another apparatus, and a processor. The processor is configured to receive information regarding at least one virtual antenna port which comprises a plurality of reference signal ports defined in a physical resource block via the interface from a network control element, and receive reference signals on the plurality of reference signal ports via the interface.

According to a third aspect of embodiments of the present invention, a method is provided which comprises
creating a at least one virtual antenna port which comprises a plurality of reference signal ports defined in a physical resource block,
sending information regarding the at least one virtual antenna port including the definition of the reference signal ports to a user equipment, and
sending reference signals on the plurality of reference signal ports to the user equipment.

According to a fourth aspect of embodiments of the present invention, a method is provided which comprises
receiving information regarding at least one virtual antenna port which comprises a plurality of reference signal ports defined in a physical resource block via the interface from a network control element, and
receiving reference signals on the plurality of reference signal ports.

Advantageous developments are defined in the dependent claims.

Thus, according to certain embodiments, one or more virtual antenna ports are provided, each of comprises a plurality of reference signal ports on which reference signals are transmitted. In this way, channel estimation, for which the reference signals may be used, can be improved.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1 shows an eNB according to an embodiment of the present invention,

FIG. 2 shows a UE according to an embodiment of the present invention,

FIG. 3 shows a signaling flow between an eNB and a UE according to an embodiment of the present invention,

FIG. 4 shows an example for a flexible CSI-RS resource configuration according to an embodiment of the present invention, and

FIG. 5 shows all possible CSI-RS resources with 2/4/8 ports per resource according to Rel. 10.

FIG. 6 shows an example of 2 tx CSI-RS resource according to Rel-10.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

As described above, according to embodiments of the present invention, downlink channel estimation by using pilot signals such as reference signals (such as CSI-RS) is to be improved. This is achieved by introducing virtual antenna ports, each of which comprises a plurality of reference signal ports defined in a physical resource block (PRB).

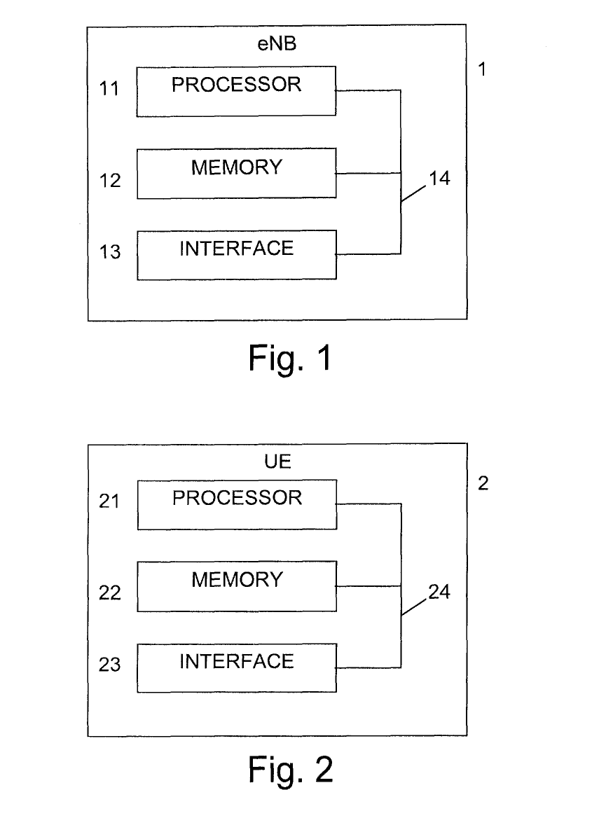

In the following, a general embodiment for an eNB (as an example for a corresponding apparatus or network control element) is described by referring to FIG. 1.

In particular, a eNB 1 comprises an interface 13 configured to provide connection to at least another apparatus, and a processor 11. The processor 11 is configured to create a at least one virtual antenna port which comprises a plurality of reference signal ports defined in a physical resource block, to send information regarding the at least one virtual antenna port including the definition of the reference signal ports via the interface to a user equipment, and to send reference signals on the plurality of reference signal ports to the user equipment.

Optionally, the apparatus may comprise a memory 12, in which programs for carrying out the functions according to the embodiments are stored. The processor 11, the interface 13 and the memory 12 may be inter-connected by a suitable connection 14, e.g., a bus or the like.

With respect to FIG. 2, a general embodiment for an UE (as an example for a corresponding apparatus or user equipment) is described.

A UE 2 comprises an interface 23 configured to provide connection to at least another apparatus, and a processor 21. The processor 21 is configured to receive information regarding at least one virtual antenna port which comprises a plurality of reference signal ports defined in a physical resource block via the interface from a network control element, and to receive reference signals on the plurality of reference signal ports via the interface.

Optionally, similar as in connection with the eNB 1 described above, the UE 2 may comprise a memory 22, in which programs for carrying out the functions according to the embodiments are stored. The processor 21, the interface 23 and the memory 22 may be inter-connected by a suitable connection 24, e.g., a bus or the like.

Hence, according to embodiments of the present invention, feedback can be determined based on the at least one virtual antenna port by averaging measurement over the reference signal ports with the associated weighting factor, and to send the feedback via the interface to the network control element.

A weighting factor may be applied to each reference signal port, so that a network element such as the UE 1 may carry out the measurements by taking into account different weights of the different ports.

According to more specific embodiments of the present invention, downlink channel estimation based on CSI-RS is improved by allowing what is considered in R10 LTE to be separate CSI-RS ports to be considered as a single port and thus effectively increase the number of resource elements available for the channel estimation. This is achieved by signaling to the UE which Rel-10 defined CSI-RS ports should be combined into a single virtual port, and potentially how to average the measurements on the separate CSI-RS antenna ports within a virtual port. In this way backwards compatibility is maintained as the individual CSI-RS ports aren't changed, moreover it allows UE supporting this feature to do different types of measurements with same CSI-RS ports (CQI like and RRM like) achieving optimal performance and minimal reference signal overhead.

According to certain embodiments, density of CSI-RS is made configurable (increased) in a backward compatible fashion. Basically, a UE is informed that a number of CSI-RS ports can be combined to one and this new combined virtual port can be considered as one of potentially more ports for the concerned measurement. In other words by combining a specific set of CSI-RS ports in a specific way a new set of virtual antenna ports are created and these form the basis for doing UE measurements.

It is signaled to the UE which CSI-RS antenna ports actually correspond to the single new virtual antenna port. This signaling is achieved by introducing a virtual antenna port concept/configuration.

Thus, according to embodiments of the present invention, a set of existing CSI-RS ports are mapped into new (virtual) ones. The mapping can potentially include weighting factors allowing to control how the CSI-RS ports are combined by the UE.

Signaling according to embodiments may comprise determining (by a eNB) that a mobile would benefit from increased CSI-RS density, signaling the increased CSI-RS to the mobile (potentially along with weighting factors), and receiving feedback (e.g., RRM like measurements) based on the increased CSI-RS. Signaling from point of view of an UE may comprise receiving signaling from the eNB that an increased CSI-RS density virtual antenna port would be available for measurements (including a weighting which could be implicit), receiving the CSI-RS, determining feedback (such as RRM like) from the CSI-RS, and sending the feedback back to the eNB.)

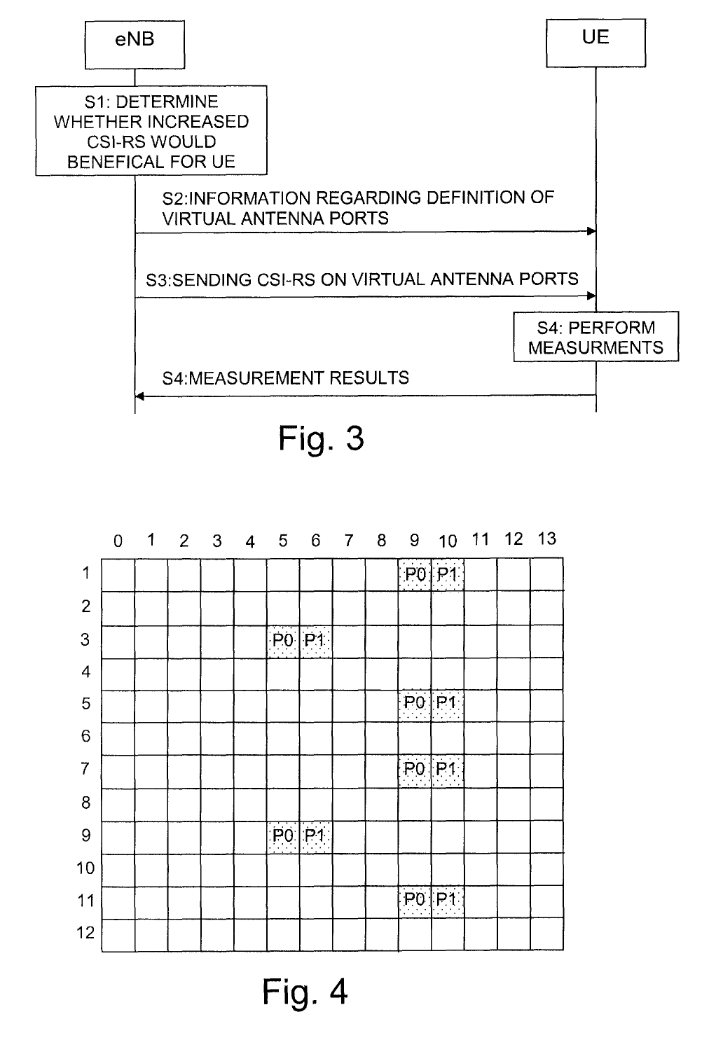

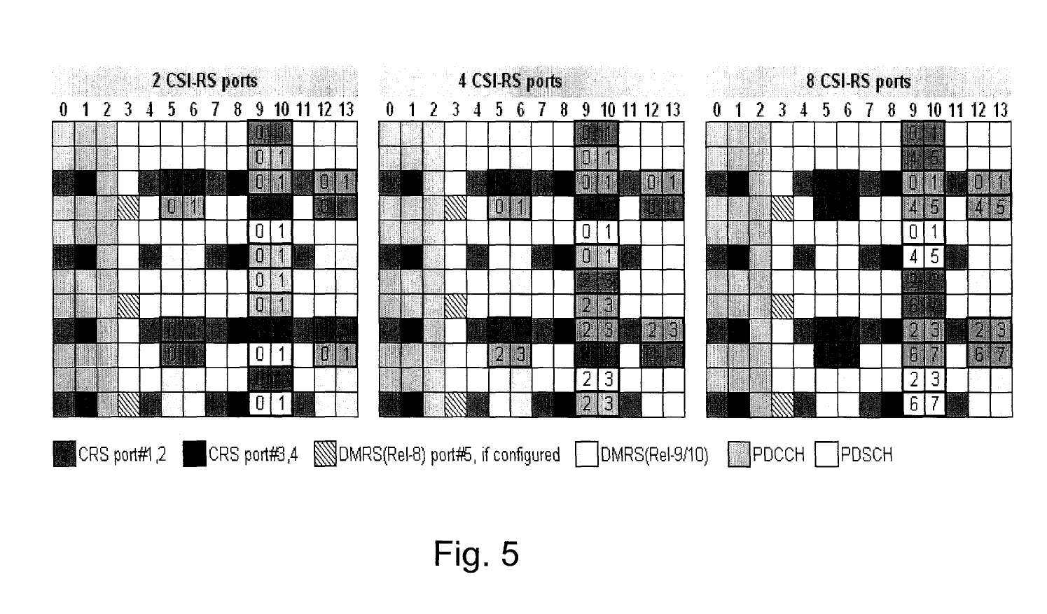

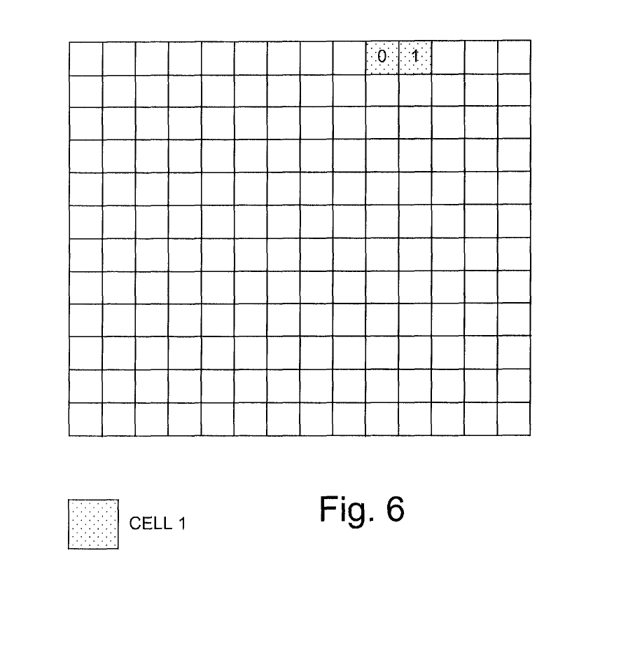

FIG. 3 shows a signaling flow between eNB and UE a mentioned above: In S1, the eNB determines whether the configuration including an increased number of reference signal ports (e.g., increased number of CSI-RS ports) would be beneficial for the UE. If so, the eNB sends information regarding the definition of the virtual antenna ports to the UE. Then, in S3 the eNB may send the reference signals (CSI-RS) on the virtual antenna ports (i.e., on the plurality of reference signal ports as defined above) to the UE. In S4, the UE performs measurements (e.g., RRM measurements) and sends the measurement results to the ENB in S4.

Thus, by embodiments of the present invention, a more robust CSI-RS based channel estimation and UE measurements are achieved.

As mentioned above, set of virtual antenna ports used for measurements is created which can have higher RE density than the R10 CSI-RS ports. A virtual antenna port is based on a specific combination of CSI-RS antenna ports as defined in the LTE R10 specification.

A virtual antenna port as proposed here is defined by
a set of CSI-RS ports
a complex valued scalar associated to each CSI-RS port

The UE creates the virtual antenna port for measurement by averaging over the indicated ports with the associated weighting factor. If the weighting factor is 1 the method reduces to simple averaging. The weighting factors could be explicitly signaled to the UE or there could be different options to select from in the spec.

FIG. 3 illustrates a flexible CSI-RS resource configuration according to an embodiment of the present invention to allow increased number of REs for RRM measurements in each PRB.

According to the example shown in FIG. 3, 12 ports may be assigned to the UE and these may be marked as grouped to two virtual antenna ports P0 and P1. These ports could be spread over the potential CSI-RS positions within one PRB. Assuming that all REs were combined to only P0, then there may be one virtual antenna port including 12 ports. To fit this invention into the current 3GPP discussions the virtual antenna port could be second level hierarchy in the definition of the CSI-RS resource

Old CSI-RS resource definition (e.g., according to TS 36.331, V10.4.0, chapter 6.3.2)
antennaPortsCount,
resourceConfig
subframe_config
period

New definition of CSI-RS resource: 2 port measurement with 2 REs (2tx MIMO)
virtual ports
   port 1 [resourceConfig_{—}1tx_{—}1, resourceConfig_{—}1tx_{—}2], weight [1,1]
   port 2 [resourceConfig_{—}1tx_{—}3, resourceConfig_{—}1tx_{—}4], weight [1,1]
subframe_config
period

An example (Example 1) is described in the following in connection with FIG. 4. In the above case of 2 port measurement with 2 REs, only four CSI-RS ports would be present, e.g., those shown in rows 1 and 3. Thus, port 1 could be P0, and, resourceConfig_{—}1tx_{—}1 may indicate RE in row 1 and column 9, and resourceConfig_{—}1x_{—}2 may indicate RE in row 3, column 5.

Port 2 could be P1, and resourceConfig_{—}1tx_{—}3 may indicate RE in row 1 and column 10, and resourceConfig_{—}1x_{—}4 may indicate RE in row 3, column 6.

It is noted that “n” in “resourceConfig_{—}1x_n” represents the specific RE position in the PRB.

The parameter “weight” is the weighting factor described above.

New definition of CSI-RS resource: 4port measurement with 2 REs per port (4tx MIMO)
virtual ports
   port 1 [resourceConfig_{—}1tx_{—}1, resourceConfig_{—}1tx_{—}2], weight [1,1]
   port 2 [resourceConfig_{—}1tx_{—}3, resourceConfig_{—}1tx_{—}4], weight [1,1]
   port 3 [resourceConfig_{—}1tx_{—}5, resourceConfig_{—}1tx_{—}6], weight [1,1]
   port 4 [resourceConfig_{—}1tx_{—}7, resourceConfig_{—}1tx_{—}8], weight [1,1]
subframe_config
period

New definition of CSI-RS resource: 1 port measurement with 4 REs (RRM measurement)
virtual ports
   port 1 [resourceConfig_{—}1tx_{—}1, resourceConfig_{—}1tx_{—}2, resourceConfig_{—}1tx_{—}3, resourceConfig_{—}1tx_{—}4], weight [1,1,1,1]
subframe_config
period

The index resourceConfig_{—}1tx_n is an enhanced version of the resourceConfig index according to Rel. 10 as that only distinguishes pairs of CDM codes allocated to the same pair of REs. ResourceConfig_{—}1tx_n has double length in order to be able to index any of the in R10 defined logical CSI-RS ports.

The above signaling examples are not exhaustive and there are many other ways the exact signaling could be implemented depending on what exact level of flexibility is needed. One other example to be mentioned explicitly, which would only require minimal changes to the signaling, is defining new interpretations of resourceConfig directly in the specification. Then the eNB can simply signal to the UE which interpretation is used. In this way only one new parameter is needed, this could be called resourceConfigInterpretation
antennaPortsCount,
resourceConfig
resourceConfigInterpretation
subframe_config
period

One interpretation could then provide 2RE per port configurations (e.g. port 0-3 for 2tx measurement with port 0 and 2 combined without specific weighting) and another interpretation allowing to configure patterns optimized for RRM like measurements (ports spread out over the PRB to be combined for better diversity).

Thus, according to embodiments of the present invention, support of more robust measurements based on CSI-RS is achieved which are potentially needed for handling more advanced UE feedback (narrow band PMI) and UE mobility in R11 and beyond.

Furthermore, backward compatibility can be maintained by indicating Rel-10 UE that the REs used for new robust measurements are with zero-power CSI-RS (muted). The muting pattern and the 16-bit bitmap defined in Rel-10 can be simply re-used.

In detail, each bit in 16-bit bitmap defined in Rel. 10 indicates whether two RE pairs would be muted or not. By referring to the example 1 described above in connection with FIG. 4, it is described in the following how a Rel. 10 UE can be informed about muting operation. For example, bit 5 and bit 8 of the 16-bit bitmap could be set as “1” (so that only the ports shown in first and the third row of FIG. 4 would be used), and the other bits could be set by “0” to mute the relevant positions. In this way, no specification modification to Rel. 10 UE would be necessary.

Thus, according to the embodiments described above, a flexible CSI-RS configuration is proposed. In this way, RRM measurement in a new carrier type without CRS based on Re1.10 CSI-RS is possible. In current Rel. 10, this is not possible due to the inflexible configuration of CSI-RS ports.

The invention is not limited to the specific examples described above.

For example, according to the embodiment described above in connection with FIG. 4, the weighting factors for determining power of REs are sent from the eNB to the UE. However, the weighting factor (weight factor) may also be predefined in network specifications or the like, so that there is no need to specifically send this to the UE. For example: New definition of CSI-RS resource: 2 port measurement with 2 REs (2tx MIMO)
virtual ports
   port 1 [resourceConfig_{—}1tx_{—}1, resourceConfig_{—}1tx_{—}2], weight [1,1]
   port 2 [resourceConfig_{—}1tx_{—}3, resourceConfig_{—}1tx_{—}4], weight [1,1]
subframe_config
period

Then weight [1,1] means RE1 and RE2 have the same power. If changing weight [1,1] to weight [2,0], it means RE1 power would be doubled and RE2 will not be useful actually. When weight value is 0, in some sense it means the relevant RE is muted. This would give more flexible muting configuration instead of using 4 RE granularity of Rel.10 muting indication, which would waste the resource in some cases. For example, cell 1 has 2 tx antennas, then it does not make sense to mute 4 RE in neighbor cell 2. Using weight method as proposed above, only two RE instead of 4 RE could be muted for example by setting weight [0,0].

Furthermore, the embodiments described above refer to CSI-RS and CSI ports. However, the CSI-RS is only an example for reference signal, and other reference signals, channel related reference signals or the like can be used as well. That is, the embodiments may also applied to other reference signals and corresponding reference signal ports than CSI-RS and CSI-RS ports.

Moreover, the embodiments described above refer in particular to LTE. However, this is also only an example, and the invention can be applied to any arrangement in which reference signals can be sent in a physical resource block.

Hence, according to aspects of embodiments of the present invention, an apparatus and a method are provided, by which at least one virtual antenna port is created which comprises a plurality of reference signal ports defined in a physical resource block. Information regarding the at least one virtual antenna port including the definition of the reference signal ports is sent to a user equipment, and reference signals are sent on the plurality of reference signal ports to the user equipment.

According to a further aspect of embodiments of the present invention, an apparatus is provided which comprises
means for receiving information regarding at least one virtual antenna port which comprises a plurality of reference signal ports defined in a physical resource block via the interface from a network control element, and
means for receiving reference signals on the plurality of reference signal ports.

According to another aspect of embodiments of the present invention, an apparatus is provided which comprises
receiving information regarding at least one virtual antenna port which comprises a plurality of reference signal ports defined in a physical resource block via the interface from a network control element, and
receiving reference signals on the plurality of reference signal ports.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. An apparatus comprising
an interface configured to provide connection to at least another apparatus, and
a processor, wherein
the processor is configured to
create a at least one virtual antenna port which comprises a plurality of reference signal ports defined in a physical resource block,
send information regarding the at least one virtual antenna port including the definition of the reference signal ports via the interface to a user equipment, and
send reference signals on the plurality of reference signal ports to the user equipment.

2. The apparatus according to claim 1, wherein the processor is configured to associate a weighting factor to each reference signal port.

3. The apparatus according to claim 2, wherein the processor is configured to send information regarding the associated weighting factors of the reference signal ports via the interface to the user equipment.

4. The apparatus according to claim 3, wherein the weighting factor for each reference signal indicates a factor for adjusting a power ratio among the reference signal ports.

5. (canceled)

6. The apparatus according to claim 1, wherein the processor is configured to send information to the user equipment that some of the reference signal ports are muted.

7. The apparatus according to claim 1, wherein the processor is configured to determine whether the user equipment would benefit from providing measurements using the plurality of reference signal ports, and to apply the at least one virtual antenna port and to send information that the plurality of reference signals would be available only in a positive determination result.

8. An apparatus comprising
an interface configured to provide connection to at least another apparatus, and
a processor, wherein
the processor is configured to
receive information regarding at least one virtual antenna port which comprises a plurality of reference signal ports defined in a physical resource block via the interface from a network control element, and
receive reference signals on the plurality of reference signal ports via the interface.

9. The apparatus according to claim 8, wherein a weighting factor is associated to each reference signal port.

10. The apparatus according to claim 9, wherein the processor is configured to receive information regarding the associated weighting factors of the reference signal ports via the interface from the network control element.

11. The apparatus according to claim 9, wherein the weighting factor for each reference signal indicates a factor for adjusting a power ratio among the reference signal ports.

12. The apparatus according to claim 10, wherein the processor is configured to determine feedback based on the at least one virtual antenna port by averaging measurement over the reference signal ports with the associated weighting factor, and to send the feedback via the interface to the network control element.

13. The apparatus according to claim 8, wherein the processor is configured to receive information from the network control element that the plurality of reference signals would be available.

14. (canceled)

15. A method comprising
creating a at least one virtual antenna port which comprises a plurality of reference signal ports defined in a physical resource block,
sending information regarding the at least one virtual antenna port including the definition of the reference signal ports to a user equipment, and
sending reference signals on the plurality of reference signal ports to the user equipment.

16. The method according to claim 15, further comprising associating a weighting factor to each reference signal port.

17. The method according to claim 16, further comprising sending information regarding the associated weighting factors of the reference signal ports to the user equipment.

18. The method according to claim 16, wherein the weighting factor for each reference signal indicates a factor for adjusting a power ratio among the reference signal ports.

19. (canceled)

20. The method according to claim 15, further comprising
sending information to the user equipment that some of the reference signal ports are muted.

21. (canceled)

22. A method comprising
receiving information regarding at least one virtual antenna port which comprises a plurality of reference signal ports defined in a physical resource block via the interface from a network control element, and
receiving reference signals on the plurality of reference signal ports.

23. The method according to claim 22, wherein a weighting factor is associated to each reference signal port.

24. The method according to claim 23, further comprising receiving information regarding the associated weighting factors of the reference signal ports from the network control element.

25. The method according to claim 23, wherein the weighting factor for each reference signal indicates a factor for adjusting a power ratio among the reference signal ports.

26. The method according to claim 24, further comprising determining feedback based on the at least one virtual antenna port by averaging measurement over the reference signal ports with the associated weighting factor, and to send the feedback via the interface to the network control element.

27. (canceled)

28. (canceled)

29. A computer program product comprising code means for performing a method according to claim 15 when run on a processing means or module.

30. The computer program product according to claim 29, wherein the computer program product is embodied on a computer-readable medium.
